(19) United States
(12) Patent Application Publication
(10) Pub. No.: US 2016/0336001 A1
(43) Pub. Date: Nov. 17, 2016

(54) SPEAKING TUBE FOR A STROLLER

(71) Applicants: Jonathan S. Katz, New York, NY (US); Alana Reed Katz, New York, NY (US)

(72) Inventors: Jonathan S. Katz, New York, NY (US); Alana Reed Katz, New York, NY (US); Emily Moyer, Brooklyn, NY (US)

(21) Appl. No.: 15/152,818

(22) Filed: May 12, 2016

Related U.S. Application Data
(60) Provisional application No. 62/160,069, filed on May 12, 2015.

(51) Int. Cl. G10K 11/22; B62B 9/12

(52) U.S. Cl. CPC G10K 11/22; B62B 9/12

(57) ABSTRACT

Provided herein are embodiments directed to a wireless speaking tube for a stroller. In one or more embodiments, the speaking tube has one or more inlets for receiving sound (e.g., human speech), which then mechanically directs the sound through a series of angled portions and flexible portions to one or more outlets. In one or more embodiments, the speaking tube is attached to a stroller arm such that the inlet is suitable for receiving sounds emanating from a child seated in the stroller, and such that the outlet amplifies the received sounds to a person pushing the stroller. In one or more embodiments, the positions of the inlet and the outlet are reversed, or the speaking tube includes two-way communication between child and person pushing the stroller.

### CROSS REFERENCE TO RELATED APPLICATION

The present application is related to and claims the benefit of U.S. Provisional Patent Application Ser. No. 62/160,069 entitled “SPEAKING TUBE FOR A STROLLER” and filed on May 12, 2015, the entire contents of which are incorporated by reference in its entirety.

### FIELD OF THE INVENTION

The present invention relates to speaking tubes, and in particular, to speaking tubes for strollers.

### BACKGROUND

Typical strollers are arranged so that a child is seated in a chair and is pushed from behind, for example, by an adult such as a parent. Usually the child is forward facing in the stroller seat. Accordingly, the child and adult are not facing each other during normal use of the stroller when the adult is pushing the child. This arrangement makes communication between the adult and child difficult, especially in noisy street environments. As such, there is a need to provide a means to improve the communication between the child and adult.

The present invention solves these and other problems.

### SUMMARY OF THE INVENTION

Embodiments of the invention are directed toward an apparatus for attachment to a wheeled carrier for mechanically directing and amplifying sound. In accordance with one embodiment, the invention is directed toward a speaking tube for attachment to a wheeled carrier in which sound is received at one location and thereafter is mechanically directed and amplified to be transmitted to a second location. For example, the speaking tube can be attached to a stroller, buggy, or other manually driven carriage. The speaking tube comprises an inlet having a sound collecting end and a connecting end, in which a first end of a first angled portion is coupled to the connecting end of the inlet. A first end of a first flexible portion is coupled to a second end of the first angled portion, such that the location of the first angled portion is adjustable. The speaking tube further comprises a straight tube, in which a proximal end of the straight tube is coupled to a second end of the first flexible portion. A second flexible portion is coupled to a distal end of the straight tube. Further, a second end of a second angled portion is coupled to the second flexible portion such that the location of the second angled portion is adjustable. Both the first and second angled portions can include a button latch that extends perpendicularly away from the outer surface of each angled portion, and in which an aperture sized and shaped to receive each button latch passes between the outer and inner surfaces of the connecting ends of each of the inlet and the outlet. A first end of the second angled portion is coupled to the connecting end of an outlet that also includes a sound transmitting end.

Continuing with the present embodiment, the inlet can further comprise a sound collector, a sound concentrator, one or more collars, and one or more ribs. The sound collector can be dome-shaped and include a concave tip a plurality of holes for receiving sound. The outlet can comprise one or more collars, one or more ribs, and a conical section open at one end for transmitting sound. Additionally, the speaking tube can comprise one or more distortion minimizers disposed within any of the first flexible portion, second flexible portion, and/or the straight tube. The speaking tube can also comprise one or more attachment clips disposed on an outer surface of the straight tube for attaching the apparatus to the wheeled carrier.

In accordance with another embodiment of the invention, an apparatus for attachment to a wheeled carrier and for mechanically directing and amplifying sound is described herein, comprising a straight tube having a proximal end and a distal end, and a pair of flexible portions, each having a first end and a second end, in which each of the first ends is coupled to the proximal and distal ends of the straight tube. The apparatus further comprises a pair of angled portions, each having a first end and a second end, in which each of the second ends is coupled to the second ends of each of the flexible portions. Additionally, the apparatus comprises a pair of inlet/outlets located at each first end of the angled portions. The pair of inlet/outlets are configured to receive sound and mechanically direct the sound into one or more of the angled portions, and configured to transmit the sound after mechanical direction. The pair of inlet/outlets can include one or more of: a sound collector, a sound concentrator, a conical section that is open for transmitting sound. Furthermore, the apparatus can further comprise one or more distortion minimizers that depend at least partially within the one or more of the pair of flexible portions.

In accordance with another embodiment of the invention, an apparatus for mechanically directing and amplifying sound is described herein, comprising an inlet having a sound collecting end and a connecting end, in which a first end of a first angled portion is coupled to the connecting end of the inlet. A first flexible portion is coupled to a second end of the first angled portion, such that the location of the first angled portion is adjustable. The apparatus further comprises a straight tube, in which a proximal end of the straight tube is coupled to the first flexible portion. A second flexible portion is coupled to a distal end of the straight tube. Further, a second end of a second angled portion is coupled to the second flexible portion such that the location of the second angled portion is adjustable. Both the first and second angled portions can include a button latch that extends perpendicularly away from the outer surface of each angled portion, and in which an aperture sized and shaped to receive each button latch passes between the outer and inner surfaces of the connecting ends of each of the inlet and the outlet. A first end of the second angled portion is coupled to the connecting end of an outlet that also includes a sound transmitting end. Further, the apparatus can comprise one or more attachment clips disposed on an outer surface of the straight tube for attaching the apparatus to a wheeled carrier.

### BRIEF DESCRIPTION OF THE DRAWING FIGURES

FIG. 1 illustrates a perspective view of a speaking tube for a wheeled carrier in accordance with at least one exemplary embodiment of the present application;

FIG. 2 illustrates an exploded side view of the speaking tube of FIG. 1;

FIG. 3 illustrates an assembled, collapsed side view of the speaking tube of FIG. 1;

FIG. 4 illustrates a first inlet/outlet of the speaking tube;

FIG. 5 illustrates a second inlet/outlet of the speaking tube;

FIG. 6 illustrates a first attachment clip of the speaking tube;

FIG. 7 illustrates a second attachment clip of the speaking tube;

FIG. 8 illustrates an angled portion of the speaking tube;

FIG. 9 illustrates a straight portion of the speaking tube;

FIGS. 10A-B illustrate a flexible, extendable portion of the speaking tube in a collapsed and extended state respectively;

FIG. 11 illustrates the speaking tube of FIG. 1 attached to a stroller; and

FIGS. 12A-B illustrate the second inlet/outlet of the speaking tube in accordance with another exemplary embodiment of the present application.

### DETAILED DESCRIPTION OF CERTAIN EMBODIMENTS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. Similarly, the phrase “one or more embodiments” as used herein does not necessarily refer to the same embodiment and the phrase “at least one embodiment” as used herein does not necessarily refer to a different embodiment. The intention is, for example, that claimed subject matter includes combinations of example embodiments in whole or in part.

By way of overview and introduction, embodiments of the present application are directed to a speaking tube for attachment to a wheeled carrier which mechanically directs and amplifies sound. The speaking tube is designed for attachment to non-motorized wheeled carriers, and as described herein, the term “wheeled carrier” does not apply to automobiles, boats, trains, motorcycles, or other motorized vehicles. In one or more embodiments, the wheeled carrier is a stroller, buggy, or other manually driven carriage. Other utilizations of the present application can be contemplated by one having skill in the art, in which a one- or two-way conversation in similar situations is ordinarily hampered by the surrounding environment.

More specifically, aspects of the present application can be appreciated in regard to the following discussion which is provided at times in the context of a one-way directional speaking tube having a first inlet/outlet for collecting sound, which then passes such sound through a series of flexible components having properties beneficial to mechanically direct and amplify such sound, to a second inlet/outlet for transmission. In this way, a party situated a distance from the second inlet/outlet is capable of appreciating the sound directed into the first inlet/outlet. More generally, the present application can include one-way embodiments in which the positions of the first inlet and second outlet are swapped, and two-way embodiments in which sound may be received at and transmitted through either the first inlet/outlet or the second inlet/outlet. In one or more embodiments, the speaking tube includes a plurality of inlets and/or outlets (e.g., two inlets, two outlets, etc.).

In one aspect, the speaking tube is suitable for attachment to a stroller in order to facilitate conversation between a child seated in the stroller and the person pushing the stroller. The speaking tube can be attached to the side, back, or front of the stroller to provide an inlet for the seated child to speak into, an outlet for the stroller-pusher to hear the child, or vice versa. In one or more embodiments, both the inlet/outlets near the seated child and the stroller pusher can be configured to receive sound and mechanically direct and amplify such sound from one party to the other.

In one aspect of the present application, the speaking tube is completely wireless and free of electrical components. Sound can be mechanically directed and amplified without the use of microphones, speakers, or other electronic audio components.

In one or more embodiments, the components discussed herein can be freely attachable and detachable from one another. Interchangeability can allow the speaking tube to redirect sound flow, or covert from one-way to two-way communication. In one or more embodiments, one or more of the components discussed herein can be more permanently affixed together to improve stability and sound amplification. Component attachment or affixment can be achieved in a variety of ways including press fit, screw fit, adhesives, button latches, fasteners (e.g., screws, nails, VELCRO, etc.), or other attachment means as are known in the art.

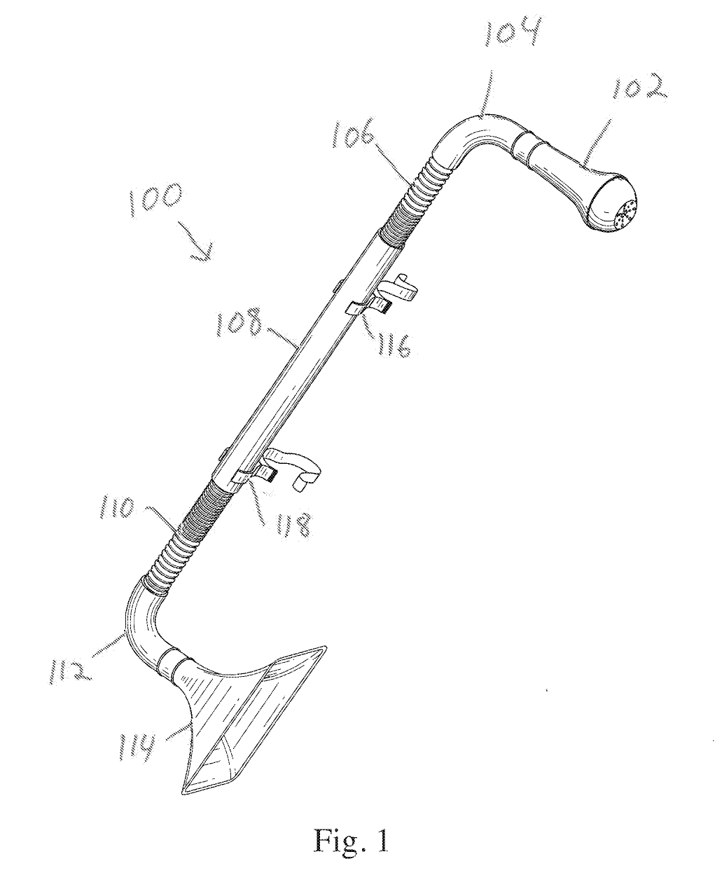

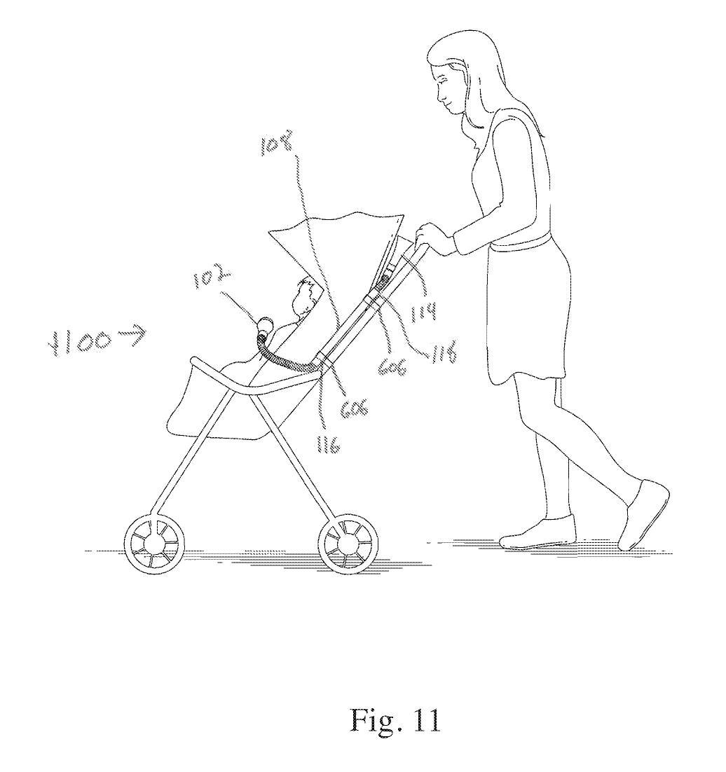

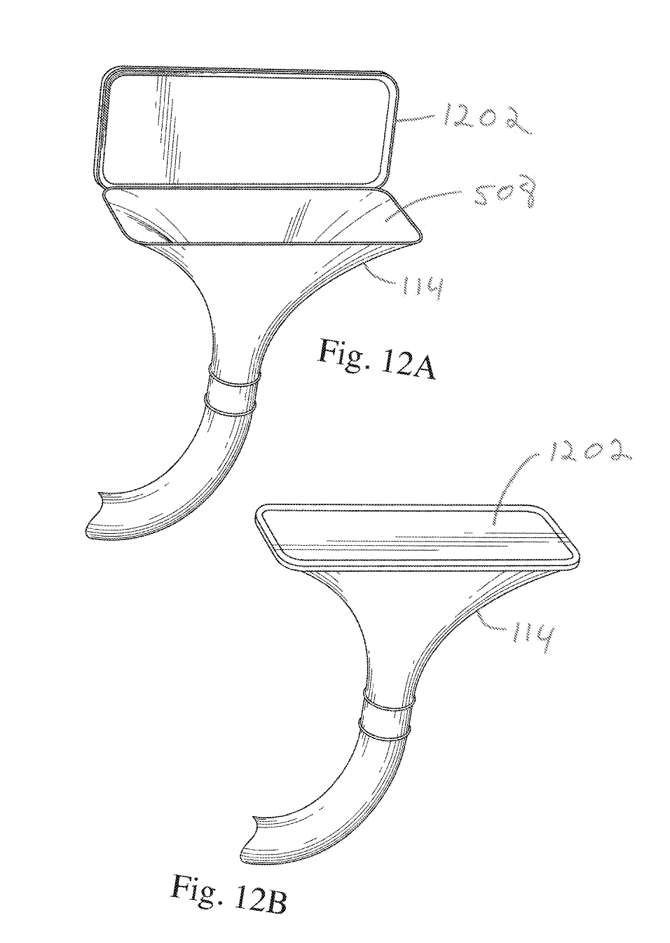

Referring to FIG. 1, an example embodiment of a speaking tube for a stroller 100 is shown. The speaking tube 100 comprises one or more speaking tube components, including a first inlet/outlet 102, a first angled portion 104, a first flexible portion 106, a straight tube 108, a second flexible portion 110, a second angled portion 112, and a second inlet/outlet portion 114. Each component includes an outer surface and an inner surface, which do not meet, thereby defining a hollow space surrounded by the inner surface in which sound can freely propagate through each component. For example, each component can be hollow or pipe-like. First and second attachment clips 116, 118 can be used to attach the speaking tube 100 to a stroller 1100, for example, as shown in FIG. 11. Each of the speaking tube components can be made of various suitable materials, such as plastic, silicone, metals, or other materials that substantially achieve the aims of mechanical sound direction and amplification as set forth herein. In one or more embodiments, the first inlet/outlet 102 and second inlet/outlet 114 are interchangeable to redirect communication flow. In one or more embodiments, the first inlet/outlet 102 and second inlet/outlet 114 are capable of both receiving and transmitting sound to facilitate two-way communication. Two-way communication may be achieved additionally, for example, by speaking tube 100 having two first inlet/outlets 102 or two second inlet/outlets 114.

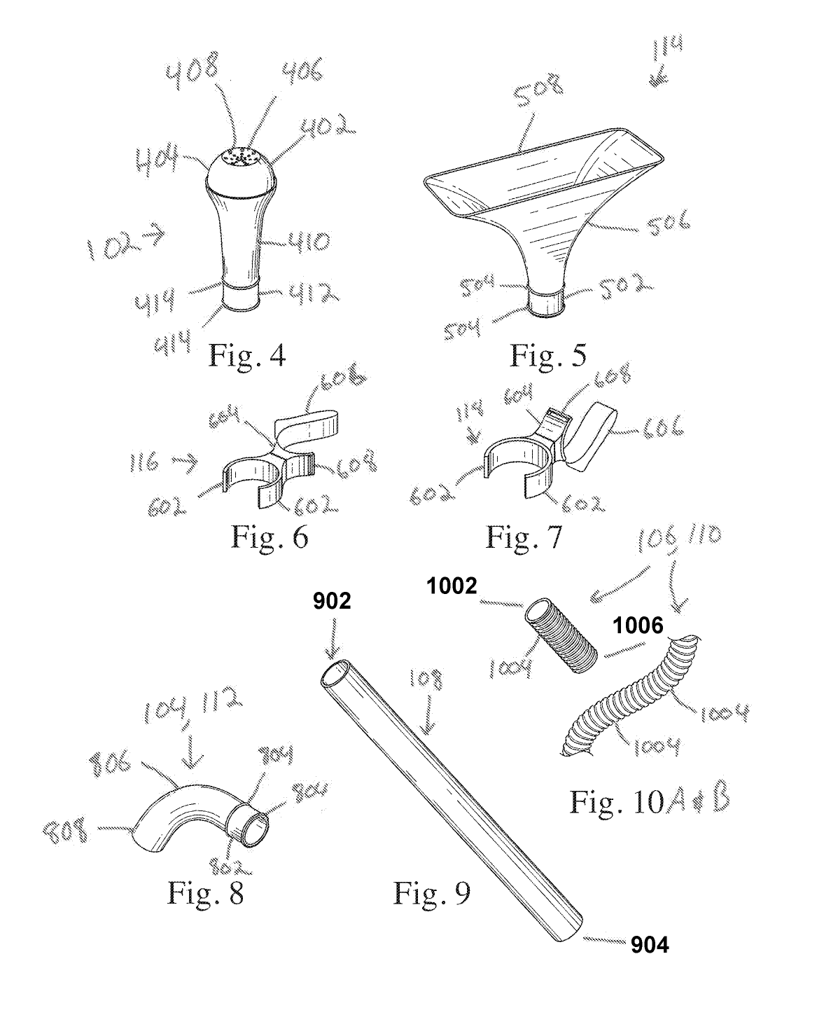

Referring to FIGS. 1 and 4, the first inlet/outlet 102 is primarily used to collect sound and direct it into the speaking tube. Accordingly, inlet 102 includes several features that enhance its ability to collect and direct sound. The inlet 102 includes a sound collector 402 at one end of the inlet (i.e., a sound collecting end). The sound collector 402 has a dome shaped portion 404 and a concave tip 406. The concave tip 406 includes a plurality of holes 408. The concave tip 406 and the holes 408 collect external sound and direct it into an inner portion of the inlet 102. Once the sound waves are inside the inlet 102, the dome shape portion 404 of the sound collector 402 helps direct the sound through the speaking tube 100 towards a sound transmitting end. However, the sound collector 402 is not limited to a dome shape, but can be other suitable shapes, such as square, rectangular, pyramid shaped, trapezoidal, or the like. The inlet 102 and/or the sound collector 402 can also be whimsically or creatively shaped, such as in the form of an old fashioned microphone, an human or animal head or ear, a telephone, a megaphone, or other conventional speaking device. The inlet 102 also includes a sound concentrator 410. In one or more embodiments, the sound concentrator 410 is conical, v-shaped, or straight in shape so that sound waves collected by the sound collector 402 are concentrated for application and transmission through the other portions of the speaking tube. The inlet can be made of various suitable materials such as plastic, for example.

In one or more embodiments in which the speaking tube facilitates two-way communication, the inlet 102 and outlet 114 both include a sound collecting end (e.g., sound collector 402).

Referring to FIGS. 1, 4, and 8, the inlet 102 is connected at its connecting end to a first angled portion 104. The inlet includes a collar 412 that has two ribs 414 at opposite ends thereof. The angled portion 104 also includes a collar 802 that has two ribs 804 at the opposite ends thereof. The collar 412 and ribs 414 and the collar 802 and ribs 804 are sized and shaped so that they can nest together. Accordingly, the ribs prevent the inlet 102 and angled portion 104 from axial separation while also allowing the inlet 102 to be able to rotate with respect to the angled portion 104. The connection of the inlet 102 to the angled portion 104 allows sound waves collected by the inlet 102 to enter the angled portion 104.

In one or more embodiments, the collars 412, 802 are nested by a press fit, a screw top, fasteners (e.g., screws, nails, etc.), or button latches. A button latch in the context of the present application includes a protrusion in an unbiased state disposed on the outer surface of at least one of the collars and extending perpendicularly away from the outer surface. In a native, unbiased state, the button is urged perpendicularly from the outer surface, for example, by springs or due to being formed using materials resistant to applied force. The button latch can be compressed into the collar by an applied force into a biased state such that at least a portion of the button latch is disposed below the outer surface of the collar. While in the biased state, the collars can be placed together for nesting. Upon releasing the applied force, the button latch is urged to the unbiased state, thereby interlocking or nesting the collars. The button latch can interlock by moving through an aperture sized and shaped to receive the button latch, which passes between the outer and inner surfaces of a collar, or by pressing into an indentation sized and shaped to receive the button latch at the inner surface of the receiving collar. In this way, the button latch interconnects the collars and prevents easy detachment.

Referring to FIGS. 1 and 8, the angled portion 104 and angled portion 112 are tubular pieces that include an angled bend 806. The angled bend 806 can be at an angle of 90° and other angles, such as 30°, 45°, 120° or 135° and other angles can be used. In one or more embodiments, the angled bend 806 is adjustable between pre-set angle options (e.g., 30°, 45°, 90°, 120°, 135°, etc.) or may be set between a range of angles (e.g., 0°-180°, 30°-150°, 45°-135°, 60°-120°). The angled bend 806 helps channel the sound waves along a directional change as the sound travels along the speaking tube. The angled tube can be made of various suitable materials such as plastic, for example.

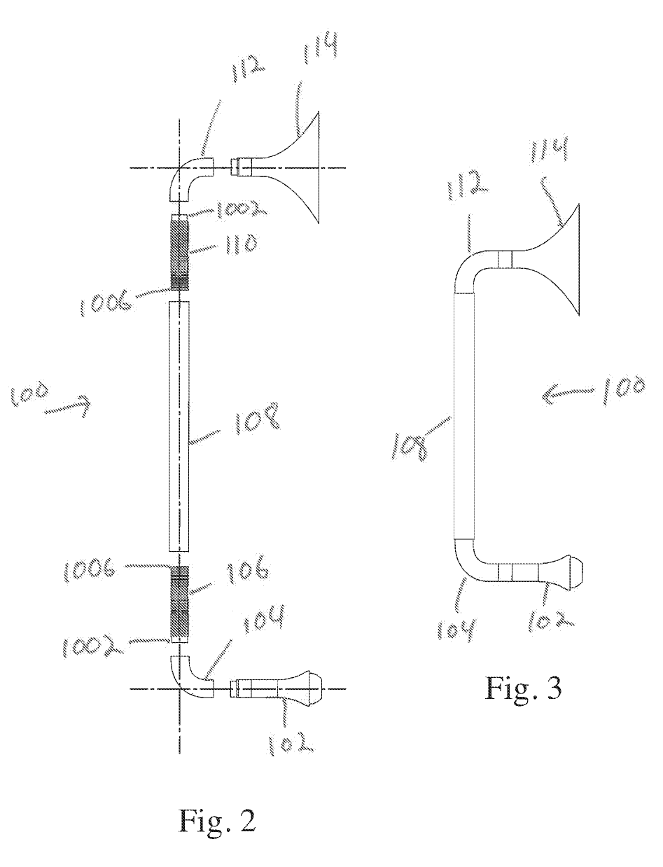

Referring to FIGS. 1, 2, 8, and 10A-B, the opposite end 808 of the angled portion 104 is connected to the flexible portion 106. The flexible portion 106 includes a first end 1002 that is sized and shaped to connect to the end 808 of the angled portion. For example, the flexible portion 106 can be connected to the angled portion 104 via a press fit, screw and thread, adhesive, or other suitable attachment means. In one or more embodiments, the angled portion 104 is freely rotatable about the longitudinal axis defined by the flexible portion 106. This may be achieved by sizing and shaping the first end 1002 and end 808 to provide the angled portion 104 with a single degree of freedom, by introducing a swivel at the connection boundary between the first end 1002 and end 808, by ball bearings, or by otherwise limiting the friction generated between the first end 1002 and end 808 upon connection, as is known in the art.

Referring to FIGS. 1, 10A-B, and 11, the flexible portion 106 allows the inlet 102 to be moved with respect to the straight tube 108. In this way, the length of the speaking tube 100 can be adjusted. The flexible portion 106 can be made of an accordion tubing that has a number of pleats or folds 1004. The accordion construction of the tubing allows the length of the flexible portion 106 to be adjusted from an extended state (e.g., FIG. 10A) to a compact state (e.g., FIG. 10B), or to any intermediate state depending on the desired length of speaking tube 100. The pleats 1004 also permit the tube 106 to bend at various angles (e.g., FIGS. 10B and 11). The pleats 1004 are also sufficiently resilient such that once the tube is bent and extended into a desired position, the inlet 102 (or outlet 114) is supported in that position. Accordingly, as shown in FIG. 11, for example, the inlet 102 (and outlet 114) can be bent into position so that the inlet 102 is positioned in proximity to and pointing toward the child and the outlet 114 can be pointing toward the adult, or vice versa.

In one or more embodiments, the flexible portion 106 further includes a distortion minimizer (not shown) disposed entirely within the flexible portion. The distortion minimizer can be a hollow cylindrical tube sleeve that extends along the longitudinal length of the inner surface of the flexible portion 106. To facilitate sound wave propagation from inlet 102 to outlet 114, the distortion minimizer has a smooth inner surface and is made of materials (e.g., plastic) that can flex as the flexible portion 106 is bent and/or extended.

Referring to FIGS. 1, 2, 9, and 10, the second end 1006 of the flexible portion 106 is attached to the first end 902 of the straight tube 108. The flexible portion 106 and the straight tube 108 are sized and shaped so that the flexible portion 106 can be disposed inside an end of the straight tube 108. For example, the inner surface of the straight tube 108 can be tapered such that the inner surface circumference decreases as the longitudinal distance from the first end 902 increases. The flexible portion 106 can then be inserted into the first end 902 and pressed into the straight tube 108 until the inner surface circumference decreases to prevent further longitudinal insertion. In one or more embodiments, the straight tube 108 includes a solid, sound permeable portion disposed along the circumference of the inner surface for anchoring the flexible portion 106. In one or more embodiments, the outer surface of the distortion minimizer is tapered. The flexible portion 106 is anchored to the inside of the straight tube 108 via suitable means, such as adhesive, press fit, or screws. In one or more embodiments, the flexible portion 106 and straight tube 108 have corresponding interlocking components (e.g., screw and thread, male and female parts, button latches, etc.) for engaging the flexible portion and straight tube. While the straight tube 108 is shown as a single, straight pipe, the straight tube can be provided with some degree of curvature, flex or bend, for example. The straight tube 108 is not limited only to a cylindrical pipe, and other forms, such as a rectangular or triangular prism, can be used as is known in the art in order to achieve the mechanical directing and sound amplification aims of the present application. However, providing unnecessary curves or bends may be undesirable as it can reduce the ability of the sound to travel along the length of the tube.

Referring to FIGS. 1-3, the flexible portion 106 is anchored at a location inside the straight tube 108 at a position such that the flexible portion 106 can be completely or nearly completely disposed within the straight tube. Once the flexible portion 106 is disposed within the straight tube 108, the end of the angled portion 104 can be connected to the end of the straight tube 108, as shown in FIG. 3. The angled portion 104 can be fastened in place via adhesive, press fit, screws, screw and thread, interlocking male and female parts, button latches, or other connecting methods as is known in the art. In one or more embodiments, the inner surface of the straight tube 108 is tapered away from the first end 902 such that the angled portion 104 can only pass a certain distance into the straight tube. Accordingly, the speaking tube 100 can be placed in a compact, stowed position.

Referring to FIGS. 1, 2 and 9, a second end 904 of the straight tube 108 is connected to a second flexible portion 110 in a similar manner as discussed above in connection with the first flexible portion 106. The second end 904 of the second flexible portion 110 is connected to a second angled portion 112 in a similar manner as discussed above as discussed with respect to the first angled portion 104. The outlet 114 is attached to the other end of the second angled portion 112 in a similar manner as the inlet 102 is connected to the first angled portion 104 as discussed above. Accordingly, the outlet 114 can be separated from the straight tube 108 and the flexible portion 110 can be extended and bent so that the outlet is in a desired position, such as pointed at the adult as shown in FIG. 11.

Referring to FIGS. 1 and 5, the outlet 114 includes a collar 502 and two ribs 504 at a connecting end that allow connection to the second angled piece 112 so that the outlet 114 can rotate with respect to the angled piece 112. As with the angled portion 104 and the flexible portion 106, the second angled piece 112 can be rotatable about the longitudinal axis of the flexible portion 110 via swivels, ball bearings, or other ways to limit friction as are known in the art. At the sound transmitting end of the outlet 114, there is a conical section 506 that leads to an opening 508 that is larger in diameter than the collar opening. Accordingly, sound traveling along the speaking tube is amplified as the sound waves exit the outlet 114. While FIG. 5 depicts outlet 114 with a conical section 506, in one or more embodiments, the outlet 114 can be shaped as a square, rectangle, pyramid, trapezoidally, a flaring horn, or can be whimsically or creatively shaped, such as in the form of a speaker, an old fashioned phonograph/gramophone, a human or animal mouth or head, headphones, telephone, or other conventional sound receiving device.

Referring to FIGS. 12A and 12B, a cover 1202 can be attached via a hinge to the outlet 114. The cover 1202 can be used to close the opening 508 when the speaking tube is not in use (e.g., to prevent dirt, water, etc. from entering the speaking tube). The cover 1202 can also be used to muffle sound traveling through the speaking tube 100 (e.g., if the child is crying, screaming, yelling, etc. instead of talking). In one or more embodiments, the cover 1202 includes a snap attachment means for clasping the cover to the outlet 114. For example, the snap attachment means can be a button snap, fastener, or complementary male and female coupling members formed at the outer edges of the cover 1202 and outlet 114.

In one or more embodiments in which the speaking tube facilitates two-way communication, the inlet 102 and outlet 114 both include a sound transmitting end (e.g., conical section 506 and opening 508).

As shown in FIGS. 1 and 11, the inlet 102, angle portion 104, flexible portion 106, straight tube 108, flexible portion 110, angled portion 112, and outlet 114 provide an inner channel so that sound waves can enter one under of the speaking tube, travel along its length, and then exit the outlet. For example, a child can speak into the inlet 102 and the sound can travel along the inner channel of the various components of the speaking tube, and then exit the outlet 114. In this way, the child can speak into the inlet 102 and can be heard at the outlet 114 by an adult pushing the stroller. The speaking tube provides an efficient means of directing and amplifying sound without the use of electronic means. The speaking tube does not require, for example, speakers, microphones, or walkie-talkies. The inner surfaces of the inlet 102, angled portions 104 and 112, and the outlet 114 can be relatively smooth and rigid. In one or more embodiments, the flexible portions 106, 110 and the straight tube 108 include a distortion minimizer, which may be a smooth hollow tube disposed within the inner surfaces of each component. This can enhance the volume and quality of the sound transmission through the tube. The use of a combination of flexible and rigid portions reduces the amount of flexible portions in the speaking tube while not significantly reducing the ability of the inlet and outlet to be positioned when used universally with strollers of various sizes and configurations. As such, the arrangement shown and described herein provides an excellent means of mechanical directing and amplification of sound.

Referring to FIGS. 1, 2, 4, 5, 8, 9, and 10A-B, each of the first inlet/outlet 102, the first angled portion 104, the first flexible portion 106, the straight tube 108, the second flexible portion 110, the second angled portion 112, and the second inlet/outlet portion 114, when separate, include one or more openings at respective ends which couple together as provided herein to assemble the speaking tube 100. For example, as discussed above, the collar 412 and ribs 414 of the inlet 102 form an open end that couples with the open end formed by collar 802 and ribs 804 of the first angled portion 104. In one or more embodiments, the connective openings of each of these respective components are sized and shaped to facilitate coupling. For example, the connective openings and/or the components themselves can be round, oval, square, rectangular, triangular, or other shapes as are known in the art to facilitate sound propagation through the speaking tube 100.

Referring to FIGS. 1, 6, 7, and 11, attachment clips 116 and 118 permit the speaking tube 100 to be attached to a stroller 1100. The attachment clips 116, 118 include deflectable arms 602 that are sized, shaped, and constructed such that the speaking tube, for example, the straight tube 108 and/or angled portions 104, 112, can be received and retained between the deflectable arms 602. The deflectable arms 602 are resiliently deflectable such that upon applying a force to the speaking tube, the arms 602 can deflect so that the speaking tube can be detached from clips 116, 118. Accordingly, when the attachment clips 116, 118 are attached to the stroller, the straight tube 108, and/or the angled portions 104, 112, the speaking tube can be selectively connected and disconnected from the stroller without having to remove the clips. The arms 602 are pivotally connected to an anchor block 604. Accordingly, the anchor block 604 can swivel with respect to the deflectable arms 602. In one or more embodiments, the anchor block 604 includes a strap 606 and a loop 608. The anchor block 604 can be placed against a component of the stroller 1100 (e.g., a metal or plastic tube) and the strap 606 can be wrapped around the other side of the stroller tube such that the metal or plastic tube is disposed between the anchor block 604 and the strap 606. The strap 606 can then be placed through the loop 608, pulled tight, and doubled back on itself. For example, if the strap has portions covered with hook and loop fastener, when the strap is doubled back on itself a tight grip between the attachment clips 116, 118 and the tube of the stroller can be maintained. The length of the strap can be adjusted so that the attachment clip can be used to attach to various different parts of different strollers, providing for universal attachment. Moreover, the swiveling between the arms 602 and the anchor block 604 allows the attachment clips to be attached to structure of the stroller at various angles. In one or more embodiments, in lieu of a strap 606, a second set of deflectable arms are included. The second set of deflectable arms can be sized, shaped, and constructed such that the attachment clips 116, 118 can be received by standard sized stroller arms (e.g., arms having diameters of one half of an inch, three-quarters of an inch, an inch, two inches, etc.).

In one or more embodiments, the inlet 102 and/or the first angled portion 104 can be fastened to other parts of the speaking tube 100 or to the stroller 1100 for storage. In one or more embodiments, the outlet 114 and/or the second angled portion 112 can be fastened to other parts of the speaking tube 100 or to the stroller 1100 for storage. For example, the inlet 102 can be fastened to the straight tube 108 by way of an attachment clip (e.g., attachment clips 116, 118), VELCRO, a fabric loop, magnets, ties, or other fastening devices. In this way, the speaking tube 100 can be temporarily disabled by limiting the noise that, for example, the adult pushing the stroller 1100 receives through the outlet 114 from a noisy or crying child seated in the stroller.

Accordingly, a universal, mechanical sound directing and amplification device is provided that can be used enhance communication between a child and an adult located behind the child while pushing the stroller.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed:

1. An apparatus for attachment to a wheeled carrier and for mechanically directing and amplifying sound comprising:
an inlet having a sound collecting end and a connecting end;
a first angled portion having a first end and a second end, wherein the first end is coupled to the connecting end of the inlet;
a first flexible portion coupled to the second end of the first angled portion, such that the location of the first angled portion is adjustable;
a straight tube having a proximal end and a distal end, the proximal end being coupled to the first flexible portion;
a second flexible portion coupled to the distal end of the straight tube;
a second angled portion having a first end and a second end, wherein the second end is coupled to the second flexible portion such that the location of the second angled portion is adjustable;
an outlet having a sound transmitting end and a connecting end, wherein the connecting end is coupled to the first end of the second angled portion.

2. The apparatus of claim 1, wherein the inlet comprises a sound collector, a sound concentrator, one or more collars, and one or more ribs.

3. The apparatus of claim 2, wherein the sound collector comprises a dome shaped portion and a concave tip having a plurality of holes for receiving sound.

4. The apparatus of claim 1, wherein the outlet comprises one or more collars, one or more ribs, and a conical section open at one end for transmitting sound.

5. The apparatus of claim 1, further comprising one or more distortion minimizers disposed within any of the: first flexible portion, second flexible portion, and/or the straight tube.

6. The apparatus of claim 1, further comprising one or more attachment clips disposed on an outer surface of the straight tube for attaching the apparatus to the wheeled carrier.

7. The apparatus of claim 1, wherein the first and second angled portions include an angled bend of 90 degrees.

8. The apparatus of claim 1, wherein the first and second angled portions include an angled bend that is adjustable between 0 and 180 degrees.

9. The apparatus of claim 1, wherein one or more of the following include a tapered inner surface: the straight tube, the first and second flexible portions, and/or the first and second angled portions.

10. The apparatus of claim 1, wherein the first angled portion is freely rotatable about a longitudinal axis of the first flexible portion.

11. The apparatus of claim 1, wherein the second angled portion is freely rotatable about a longitudinal axis of the second flexible portion.

12. The apparatus of claim 1, wherein the first and second angled portions each have a button latch extending perpendicularly away from the outer surface of each angled portion, and wherein an aperture sized and shaped to receive each button latch passes between the outer and inner surfaces of the connecting ends of each of the inlet and the outlet.

13. An apparatus for attachment to a wheeled carrier and for mechanically directing and amplifying sound, comprising:
a straight tube having a proximal end and a distal end;
a pair of flexible portions, each having a first end and a second end, wherein each of the first ends is coupled to the proximal and distal ends of the straight tube;
a pair of angled portions, each having a first end and a second end, wherein each of the second ends is coupled to the second ends of each of the flexible portions; and
a pair of inlet/outlets disposed at each first end of the angled portions,
wherein each of the pair of inlet/outlets are configured to receive sound and mechanically direct the sound into one or more of the angled portions, and configured to transmit the sound after mechanical direction.

14. An apparatus according to claim 13, wherein the pair of inlet/outlets comprise a sound collecting end having a sound collector and a sound concentrator.

15. An apparatus according to claim 13, wherein the pair of inlet/outlets comprise a sound transmitting end having a conical section that is open for transmitting sound.

16. An apparatus according to claim 13, further comprising one or more distortion minimizers depending at least partially within one or more of the pair of flexible portions.

17. An apparatus according to claim 16, wherein the distortion minimizer is a smooth, hollow cylindrical tube.

18. An apparatus according to claim 13, wherein the pair of inlet/outlets are interchangeable.

18. An apparatus according to claim 13, wherein the pair of inlet/outlets comprise:
a sound collector and a sound concentrator disposed

19. An apparatus for mechanically directing and amplifying sound comprising:
an inlet having a sound collecting end and a connecting end;
a first angled portion having a first end and a second end, wherein the first end is coupled to the connecting end of the inlet;
a first flexible portion coupled to the second end of the first angled portion, such that the location of the first angled portion is adjustable;
a straight tube having a proximal end and a distal end, the proximal end being coupled to the first flexible portion;
a second flexible portion coupled to the distal end of the straight tube;
a second angled portion having a first end and a second end, wherein the second end is coupled to the second flexible portion such that the location of the second angled portion is adjustable;
an outlet having a sound transmitting end and a connecting end, wherein the connecting end is coupled to the first end of the second angled portion.

20. An apparatus according to claim 19, further comprising one or more attachment clips disposed on an outer surface of the straight tube for attaching the apparatus to a wheeled carrier.
